(19) United States
(12) Patent Application Publication
(10) Pub. No.: US 2012/0094154 A1
(43) Pub. Date: Apr. 19, 2012

(54) BATTERY SYSTEMS WITH BATTERY GAUGE FUNCTIONS

(76) Inventor: Guoxing LI, Sunnyvale, CA (US)

(21) Appl. No.: 12/903,746

(22) Filed: Oct. 13, 2010

(51) Int. Cl. H01M 10/50; H01M 10/48

(52) U.S. Cl. 429/62; 429/90

(57) ABSTRACT

A battery system includes an indicator, a sensor, and a controller. The indicator has multiple channels and is operable for displaying information about a battery cell unit according to control signals received via the channels. The channels include a first channel and the control signals include a first control signal. The sensor is operable for generating a sense signal. The controller has a first pin coupled to both the first channel and the sensor. The controller controls the first pin to apply the first control signal to the first channel when operating in the gauging mode and controls the first pin to receive the sense signal when operating in the sensing mode

### BACKGROUND

Rechargeable battery packs are widely used in portable devices such as laptop computers, cell phones, personal digital assistants (PDAs), and digital cameras. A rechargeable battery pack employs a battery gauge circuit to indicate whether the capacity of the battery pack is depleted.

FIG. 1 illustrates a block diagram of a conventional battery pack 100. The battery pack 100 includes a cell unit 102, a battery gauge circuit 104, and an indicator 105. The cell unit 102 includes multiple battery cells 102_1, 102_2 and 102_3 in series. The battery gauge circuit 104 can be integrated on an integrated circuit (IC) chip and includes various types of pins such as multiple voltage detection pins B0-B3, a pair of current detection pins ISP and ISN, and multiple general purpose input and output (GPIO) pins GP0-GP10. The pins B0-B3 coupled to the battery cells 102_1-102_3 detect cell voltages of the battery cells 102_1-102_3. The pins ISP and ISN coupled to a resistor 106 detect a current I1 flowing through the battery cells 102_1-102_3. Based upon the cell voltages and the current I1, the battery gauge circuit 104 obtains a state of charge (SOC) of the battery cells 102_1-102_3, which indicates a remaining capacity of the battery cells 102_1-102_3.

The indicator 105 includes multiple channels CHN1-CHN5 coupled to the pins GP6-GP10, respectively. The indicator 105 further includes multiple light emitting diodes (LEDs) D1-D5 coupled to the channels CHN1-CHN5, respectively. As such, the battery gauge circuit 104 can light up an LED, e.g., D1, by applying a low level electric signal to a corresponding channel, e.g., CHN1, via a corresponding pin, e.g., GP10, and can cut off the LED D1 by applying a high level electric signal to the channel CHN1 via the pin GP10. In operation, a user can push a button 108 to generate an interrupt. The battery gauge circuit 104 controls the pin GP5 to receive the interrupt and controls the pins GP6-GP10 to display the state of charge of the cell unit 102 on the LEDs D1-D5 in response to the interrupt. For example, if only the LED D1 is lit, it indicates the SOC of the cell unit 102 is 20%. Likewise, if only the LEDs D1 and D2 are lit, it indicates the SOC of the cell unit 102 is 40%.

Furthermore, in order to protect the battery pack 100 from suffering one or more abnormal temperature conditions, the battery pack 100 includes multiple thermistors RT1-RT4 for sensing temperatures of multiple components within the battery pack 100, e.g., the battery cells 102_1-102_3, respectively. The battery gauge circuit 104 controls the pin GP4 to provide a supply voltage to the thermistors RT1-RT4, such that the thermistors RT1-RT4 generate respective sense signals. The battery gauge circuit 104 controls the pins GP0-GP3 to receive the sense signals. Using the sense signals, the battery gauge circuit 104 can determine whether the battery pack 100 is undergoing abnormal temperature conditions.

However, the battery gauge circuit 104 has a relatively large number of pins, e.g., 18 pins as shown in FIG. 1. Therefore, the silicon chip area of the battery gauge circuit 104 is relatively large, which leads to a relatively high cost of the battery pack 100.

### SUMMARY

In one embodiment, a battery system includes an indicator, a sensor, and a controller. The indicator has multiple channels and is operable for displaying information about a battery cell unit according to control signals received via the channels. The channels include a first channel and the control signals include a first control signal. The sensor is operable for generating a sense signal. The controller has a first pin coupled to both the first channel and the sensor. The controller controls the first pin to apply the first control signal to the first channel when operating in a gauging mode and controls the first pin to receive the sense signal when operating in a sensing mode.

### BRIEF DESCRIPTION OF THE DRAWINGS

Features and advantages of embodiments of the subject matter will become apparent as the following detailed description proceeds, and upon reference to the drawings, wherein like numerals depict like parts, and in which:

FIG. 1 illustrates a block diagram of a conventional battery pack.

FIG. 2 illustrates a block diagram of a battery system, in accordance with one embodiment of the present invention.

FIG. 3 illustrates a table of operations of GPIO pins, in accordance with one embodiment of the present invention.

FIG. 4 illustrates an example of a block diagram of a controller, in accordance with one embodiment of the present invention.

FIG. 5 illustrates another example of a block diagram of a battery system, in accordance with one embodiment of the present invention.

FIG. 6 illustrates another example of a block diagram of a battery system, in accordance with one embodiment of the present invention.

FIG. 7 illustrates a flowchart of operations of a battery system, in accordance with one embodiment of the present invention.

### DETAILED DESCRIPTION

Reference will now be made in detail to the embodiments of the present invention. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

Some portions of the detailed descriptions that follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those utilizing physical manipulations of physical quantities. Usually, although not necessarily, these quantities take the form of electrical or magnetic signals capable of being stored, transferred, combined, compared, and otherwise manipulated in a computer system. It has proven convenient at times, principally for reasons of common usage, to refer to these signals as transactions, bits, values, elements, symbols, characters, samples, pixels, or the like.

Embodiments described herein may be discussed in the general context of machine-executable (e.g., computer-executable) instructions residing on some form of machine-readable (e.g., computer-readable) storage medium, such as program modules, executed by one or more computers or other devices. By way of example, and not limitation, machine-readable storage media may comprise non-transitory computer-readable storage media and communication media; non-transitory computer-readable media include all computer-readable media except for a transitory, propagating signal. Generally, program modules include routines, programs, objects, components, data structures, etc., that perform particular tasks or implement particular abstract data types. The functionality of the program modules may be combined or distributed as desired in various embodiments.

Storage media includes volatile and nonvolatile, removable and non-removable media implemented in any method or technology for storage of information such as computer-readable instructions, data structures, program modules or other data. Computer storage media includes, but is not limited to, random access memory (RAM), read only memory (ROM), electrically erasable programmable ROM (EEPROM), flash memory or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information and that can accessed to retrieve that information.

Communication media can embody computer-executable instructions, data structures, and program modules, and includes any information delivery media. By way of example, and not limitation, communication media includes wired media such as a wired network or direct-wired connection, and wireless media such as acoustic, radio frequency (RF), infrared and other wireless media. Combinations of any of the above can also be included within the scope of computer-readable media.

Embodiments in accordance with the present disclosure provide a battery system. In one embodiment, the battery system includes an indicator, a sensor, and a controller. The indicator has multiple channels and is operable for displaying information about a parameter of a battery cell unit according to control signals in the channels. The channels include a first channel, and the control signals include a first control signal. The sensor is operable for generating a sense signal.

Advantageously, the controller has a first pin that is coupled to both the first channel and the sensor, and is operable for operating in a gauging mode and a sensing mode. The controller controls the first pin to apply the first control signal to the first channel in the gauging mode, and controls the first pin to receive the sense signal in the sensing mode. Consequently, the number of pins in the controller is decreased. As such, the chip area of the controller is decreased, the chip package can be smaller and cheaper, the printed circuit board (PCB) size can be reduced, and the cost of the battery system is reduced.

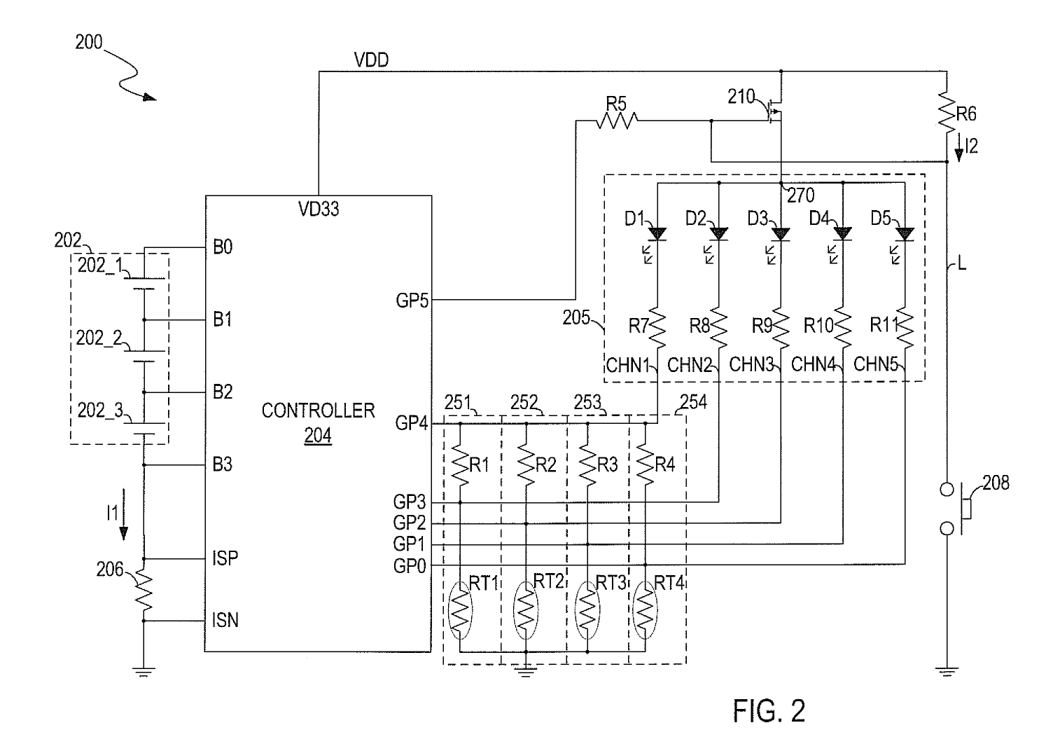

FIG. 2 illustrates a block diagram of a battery system 200, in accordance with one embodiment of the present invention. In the example of FIG. 2, the battery system 200 includes a battery cell unit 202, a controller 204, an indicator 205, multiple sensors 251-254, a resistor 206, a button 208, and a switch 210. The battery cell unit 202 includes multiple battery cells 202_1-202_3 coupled in series. In one embodiment, the controller 204 can be a battery gauge circuit integrated on an integrated circuit (IC) chip and includes multiple pins such as multiple voltage sensing pins B0-B3, a pair of current sensing pins ISP and ISN, a pin VD33, and multiple general purpose input and output (GPIO) pins GP0-GP5. The pin VD33 provides a supply voltage VDD. The controller 204 controls the pins B0-B3, ISP and ISN to detect a parameter of the battery cell unit 202, e.g., a state of charge (SOC) of the battery cell unit 202. The controller 204 further operates in a gauging mode and a sensing mode to control the pins GP0-GP5, in one embodiment. In the gauging mode, the controller 204 controls the pins GP0-GP5 to display the detected parameter on the indicator 205. In the sensing mode, the controller 204 controls the same pins GP0-GP5 to receive multiple sense signals generated by the sensors 251-254.

The battery cells 202_1-202_3 in the battery cell unit 202 can be, but are not limited to, Lilon/Polymer cells, lead-acid cells, or NiCD/NiMH cells. Although three battery cells are shown in the example of FIG. 2, a different number of battery cells can be included in the battery cell unit 202. The battery cells 202_1-202_3 are coupled to the pins B0-B3 of the controller 204. For example, the battery cell 202_1 is coupled between the pin B0 and the pin B1; the battery cell 202_2 is coupled between the pin B1 and the pin B2; and the battery cell 202_3 is coupled between the pin B2 and the pin B3. As such, the controller 204 configures the pins B0-B3 to detect cell voltages of the battery cells 202_1-202_3.

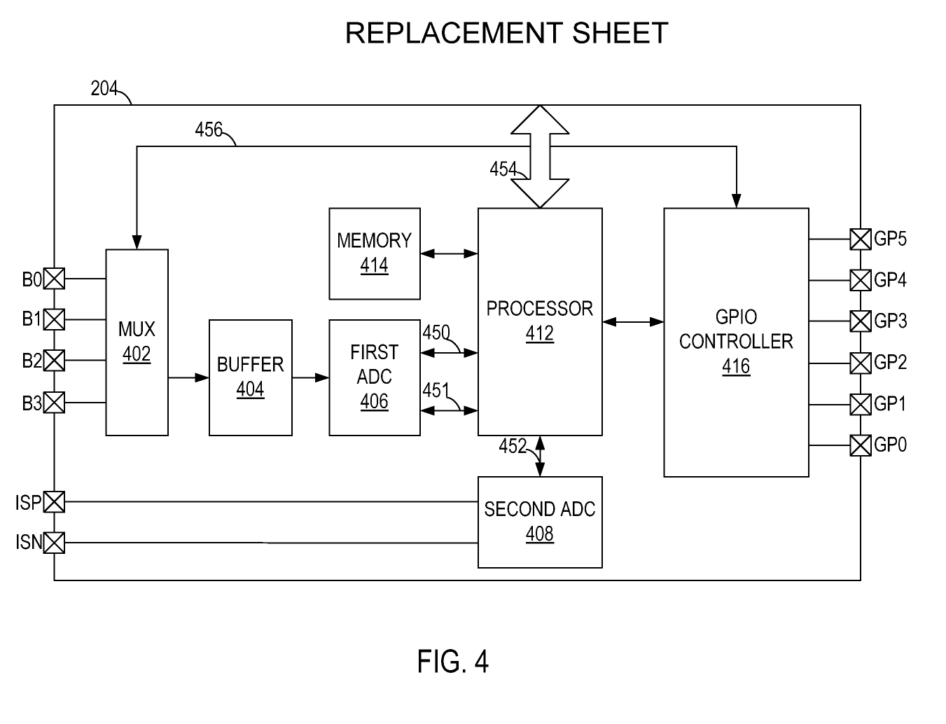

In one embodiment, the resistor 206 is coupled to the pins ISP and ISN of the controller 204. The controller 204 controls the pins ISP and ISN to detect a current I1 flowing through the battery cells 202_1-202_3. For example, a voltage between the pins ISP and ISN can indicate the current I1. The controller 204 determines information about (e.g., a measure or value of) a parameter of the battery cell unit 202 based upon the detected cell voltages and the detected current I1, which is further described in relation to FIG. 4. The parameter can be, but is not limited to, a state of charge (SOC) of the battery cell unit 202, an open-circuit voltage of the battery cell unit 202, or the current I1 flowing through the battery cell unit 202.

In one embodiment, the indicator 205 includes multiple light emitting diodes (LEDs) D1-D5, multiple resistors R7-R11, and multiple channels CHN1-CHN5. Although five LEDs are shown in the example of FIG. 2, a different number of LEDs can be included in the indicator 205. The channels CHN1-CHN5 are coupled to the LEDs D1-D5, respectively. For example, the channel CHN1 is coupled to the LED D1 through the resistor R7, the channel CHN2 is coupled to the LED D2 through the resistor R8, the channel CHN3 is coupled to the LED D3 through the resistor R9, the channel CHN4 is coupled to the LED D4 through the resistor R10, and the channel CHN5 is coupled to the LED D5 through the resistor R11.

In one embodiment, the button 208 has a first end coupled to ground, and a second end coupled to the supply voltage VDD via a resistor R6. In one embodiment, the switch 210 is a P-type metal-oxide-semiconductor field effect transistor (MOSFET). The pin GP5 is coupled to both a gate terminal of the switch 210 and the second end of the button 208.

In operation, the button 208 is pushed down to conduct a current path L when the button 208 is pressed by a user and is pulled up automatically to cut off the current path L once the user releases his/her hand, in one embodiment. More specifically, when the battery system 200 is started, the button 208 is released and the current path L is cut off. Thus, no current flows through the resistor R6, and a high electric signal is applied to the pin GP5. When the button 208 is pressed by a user, the button 208 conducts the current path L. A current 12 flows through the resistor R6 and the pin GP5 is connected to the ground. Thus, a low electric signal is applied to the pin GP5. In other words, an interrupt, e.g., a falling edge, is generated at the pin GP5 when the button 208 is pressed.

Moreover, when the button 208 is released (pulled up), the controller 204 can determine the voltage level at the pin GP5. For example, the controller 204 can set the voltage at the pin GP5 to a high electric level or a low electric level.

Furthermore, the controller 204 is capable of operating in a gauging mode and a sensing mode to control the pins GP0-GP5. In one embodiment, the pin GP5 is configured by the controller 204 to receive the interrupt generated by the button 208 and to turn on and off the switch 210 so as to enable and disable the indicator 205.

In one embodiment, when the controller 204 receives the interrupt at the pin GP5, the controller 204 is switched to the gauging mode. In the gauging mode, the controller 204 provides a low electric signal at the pin GP5, which turns on the switch 210. Thus, the indicator 205 is enabled. Then, the indicator 205 displays information about the parameter associated with the battery cell unit 202 according to multiple control signals SIG_{CON1}-SIG_{CON5} within the channels CHN1-CHN5, respectively. More specifically, the LEDs D1-D5 can be lit up or cut off according to the control signals SIG_{CON1}-SIG_{CON5} in the channels CHN1-CHN5. For example, the control signal SIG_{CON1} in the channel CHN1 can be a high electric signal or a low electric signal. If SIG_{CON1} is low, the LED D1 is lit up. If SIG_{CON1} is high, the LED D1 is cut off. The LEDs D2-D5 operate similarly as the LED D1.

In the following descriptions, the indicator 205 is described as displaying information about the SOC of the battery cell unit 202 for illustrative purposes; however, the indicator 205 can be used to display information about other parameters as mentioned above. In one embodiment, if only D1 is lit up, it indicates the SOC of the battery cell unit 202 is 20%. If only D1 and D2 are lit up, it indicates the SOC of the battery cell unit 202 is 40%. If only D1, D2, and D3 are lit up, it indicates the SOC of battery cell unit 202 is 60%. If only D1-D4 are lit up, it indicates the SOC of battery cell unit 202 is 80%. If all the LEDs are lit up, it indicates the battery cell unit 202 is fully charged.

In one embodiment, each of the sensors 251-254 includes a respective thermistor and a respective resistor in series. For example, the sensor 251 includes a thermistor RT1 and a resistor R1; the sensor 252 includes a thermistor RT2 and a resistor R2; the sensor 253 includes a thermistor RT3 and a resistor R3; and the sensor 254 includes a thermistor RT4 and a resistor R4. In one embodiment, the thermistor, e.g., RT1, RT2, RT3 or RT4, can be a negative temperature coefficient (NTC) thermistor, which exhibits a decrease in electrical resistance when subjected to an increase in body temperature. Alternatively, the thermistor can be a positive temperature coefficient (PTC) thermistor, a thermocouple, a resistance temperature detector (RTD), or an IC temperature sensor.

The thermistors RT1-RT4 can be used to sense temperatures of various components in the battery system 200. For example, the thermistors RT1-RT3 can be placed on the battery cells 202_1-202_3, respectively, to sense temperatures of the battery cells 202_1-202_3. The thermistor RT4 can be placed on a charge or discharge switch (not shown) to sense a temperature of the switch.

In one embodiment, the controller 204 stays in the gauging mode for a predetermined time period T, e.g., three seconds. After T is expired, the controller 204 is switched to the sensing mode. In the sensing mode, the controller 204 generates a high electric signal at the pin GP5 to turn off the switch 210. As such, the indicator 205 is disabled. Thus, all the LEDs D1-D5 are cut off, whether the control signals in the channels CHN1-CHN5 are high electric signals or low electric signals. Since the LEDs D2-D5 are reverse biased to decouple a common node 270 to the sensors 251-254, different sensors 251-254 are isolated from each other in the sensing mode. Meanwhile, in the sensing mode, the controller 204 controls the pin GP4 to generate a supply voltage V_{SUPPLY} to drive the sensors 251-254. As such, the sensors 251-254 provide multiple sense signals SIG_{SEN1}-SIG_{SEN4} indicating the sensed temperatures at the pins GP0-GP3, respectively. For example, the resistor R1 and the thermistor RT1 of the sensor 251 constitute a voltage divider to provide a sense signal SIG_{SEN1} at the pin GP3, e.g., SIG_{SEN1} can be a voltage across the thermistor RT1 that varies in accordance with the temperature of the battery cell 202_1. The sensors 252-254 operate similarly as the sensor 251.

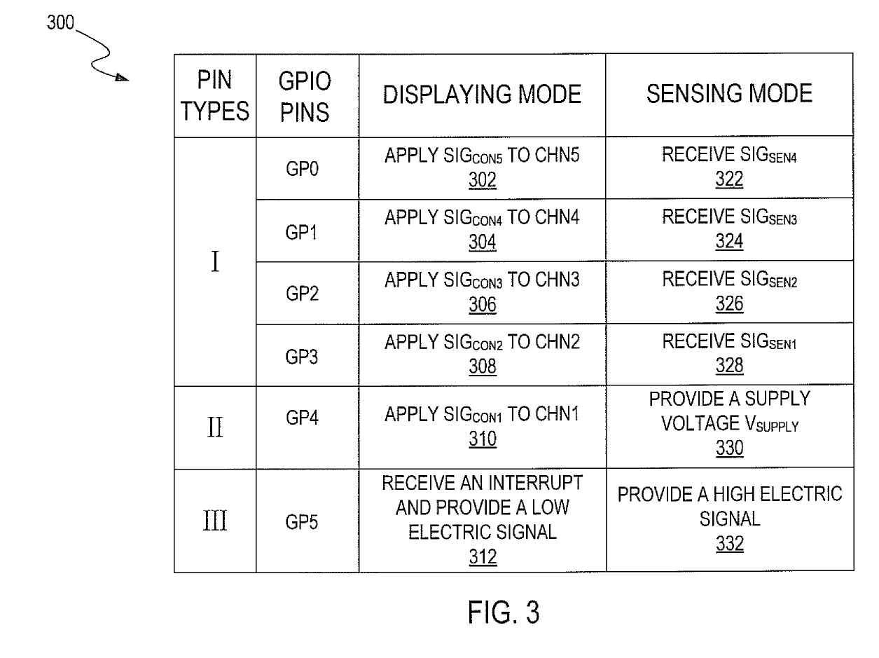

Furthermore, in the sensing mode, the pins GP0-GP3 are configured by the controller 204 to receive the sense signals SIG_{SEN1}-SIG_{SEN4}. In one embodiment, the sense signals SIG_{SEN1}-SIG_{SEN4} can be used by the controller 204 to determine whether an abnormal temperature condition, e.g., an over-temperature condition, occurs. Accordingly, the controller 204 can protect the battery system 200 from suffering the abnormal temperature condition. For example, if the sense signal SIG_{SEN1} at the pin GP3 indicates the battery cell 202_1 undergoes an over-temperature condition during a charging process, the controller 204 can turn off a charging switch (not shown) to terminate the charging process. The operations of the GPIO pins GP0-GP5 are further described in relation to FIG. 3. The battery system 200 can have other configurations, and is not limited to the example of FIG. 2.

FIG. 3 illustrates a table 300 of operations of the GPIO pins GP0-GP5, in accordance with one embodiment of the present invention. FIG. 3 is described in combination with FIG. 2. In the example of FIG. 3, the GPIO pins are classified into three types I, II and III according to their functions performed in the gauging mode and in the sensing mode.

The pins GP0-GP3 are type I GPIO pins. In one embodiment, each of the pins GP0-GP3 applies a control signal to a corresponding channel in the gauging mode, and receives a sense signal from a corresponding sensor in the sensing mode. More specifically, the pin GP0 applies the control signal SIG_{CON5} to the channel CHN5 in the gauging mode in block 302, and receives the sense signal SIG_{SEN4} generated by the sensor 254 in the sensing mode in block 322. The pin GP1 applies the control signal SIG_{CON4} to the channel CHN4 in the gauging mode in block 304, and receives the sense signal SIG_{SEN3} generated by the sensor 253 in the sensing mode in block 324. The pin GP2 applies the control signal SIG_{CON3} to the channel CHN3 in the gauging mode in block 306, and receives the sense signal SIG_{SEN2} generated by the sensor 252 in the sensing mode in block 326. The pin GP3 applies the control signal SIG_{CON2} to the channel CHN2 in the gauging mode in block 308, and receives the sense signal SIG_{SEN1} generated by the sensor 251 in the sensing mode in block 328.

The pin GP4 is a type II GPIO pin. In block 310, the pin GP4 applies the control signal SIG_{CON1} to the channel CHN1 in the gauging mode. In block 330, the same pin GP4 provides a supply voltage V_{SUPPLY} to drive all the sensors 251-254 in the sensing mode.

The pin GP5 is a type III GPIO pin. In block 312, the pin GP5 receives an interrupt for switching the controller 204 to the gauging mode. In the gauging mode, the pin GP5 provides a low electric signal to turn on the switch 210, e.g., for a predetermined time period T, such that the indicator 205 is enabled during T. In the sensing mode, the pin GP5 provides a high electric signal in block 314 to turn off the switch 210. Thus, the indicator 205 is disabled in the sensing mode.

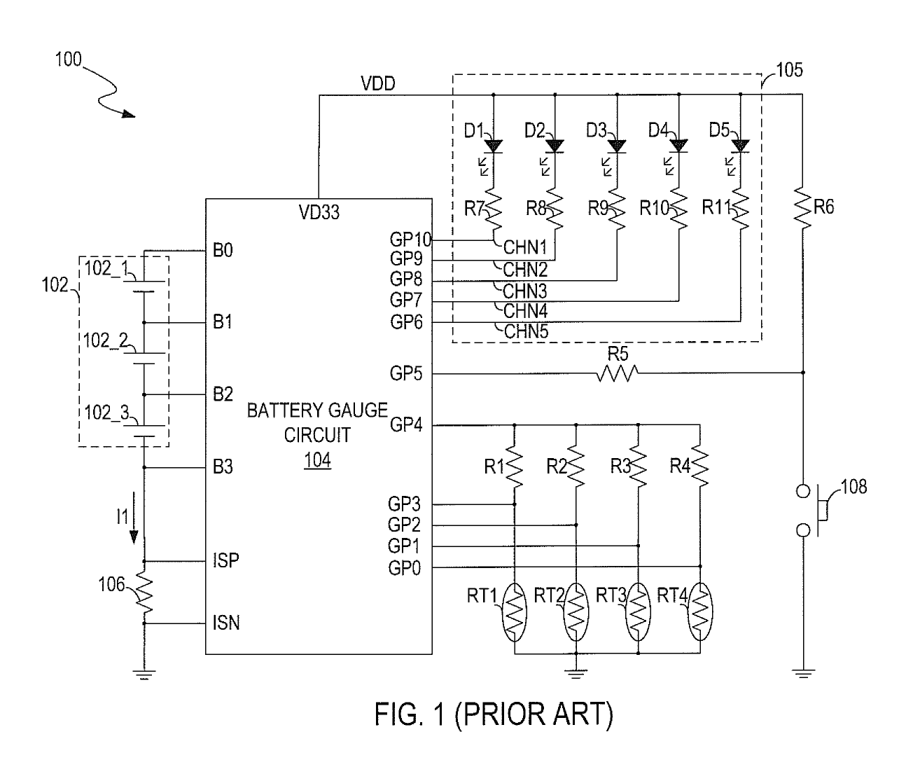

Advantageously, by using the multi-function pins GP0-GP5, the controller 204 can operate in the gauging mode to display the parameter on the indicator 205, and can operate in the sensing mode to obtain temperature sensing information from the multiple sensors 251-254. Consequently, the number of GPIO pins in the controller 204 is decreased compared to the battery gauge circuit 104 in FIG. 1. For example, a total of 5 pins, e.g., GP6-GP10 in FIG. 1, can be removed from the controller 204. As such, the chip area of the controller 204 is decreased, the chip package can be smaller and cheaper, the size of a printed circuit board (PCB) can be reduced, and the cost of the battery system 200 is reduced.

FIG. 4 illustrates an example of a block diagram of the controller 204, in accordance with one embodiment of the present invention. FIG. 4 is described in combination with FIG. 2 and FIG. 3. In the example of FIG. 4, the controller 204 includes a multiplexer (MUX) 402, a buffer 404, a first analog to digital converter (ADC) 406, a second ADC 408, a processor 412, a memory 414, and a GPIO controller 416.

As described in relation to FIG. 2, the voltage sensing pins B0-B3 receive multiple voltage detection signals indicating the cell voltages of the battery cells 202_1-202_3, respectively, which are further transferred to the multiplexer 402. For example, voltages of the voltage detection signals can be proportional to the cell voltages. Moreover, in the sensing mode, the GPIO controller 416 receives multiple temperature sense signals SIG_{SEN1}-SIG_{SEN4} from the pins GP0-GP3 and transfers the temperature sense signals SIG_{SEN1}-SIG_{SEN4} to the multiplexer 402 via a bus 456. The multiplexer 402 time-divisionally forwards multiple analog signals including the voltage detection signals and the temperature sense signals SIG_{SEN1}-SIG_{SEN4} to the buffer 404. The buffer 404 buffers the analog signals and transfers the analog signals to a first analog-to-digital converter (ADC) 406. The first ADC 406 converts the analog signals to multiple digital signals such as digital voltage detection signals 450 and digital temperature sense signals 451. Similarly, the second ADC 408 coupled to the current sensing pins ISP and ISN converts a current detection signal indicating the current I1 to a digital current detection signal 452.

The processor 412 can be a central processing unit (CPU), a microprocessor, a digital signal processor, or any other such device that can read and execute programming instructions. The memory 414 stores multiple machine-executable instructions and machine-readable data. In one embodiment, the machine-readable data includes capacity data indicating a full capacity C_{FULL} of the battery cell unit 202 during the last charging and discharging cycle. In one embodiment, the processor 412 executes the machine-executable instructions stored in the memory 414 to read the digital voltage detection signals 450 from the first ADC 406 and to read the digital current detection signals 452 from the second ADC 408. Accordingly, the processor 412 obtains information for the cell voltages, the current I1 flowing through the battery cells 202_1-202_3, and the temperatures of the battery cell unit 202.

The processor 412 generates control commands to control the GPIO controller 416. Accordingly, the GPIO controller 416 configures the GPIO pins GP0-GP5 to complete different functions in the gauging mode and in the sensing mode, as discussed in relation to FIG. 2 and FIG. 3.

Based on the current I1, the cell voltages and the temperatures of the battery cell unit 202, the processor 412 calculates the SOC of the cell unit 202, in one embodiment. For example, the processor 412 performs a coulomb count on the current I1 to obtain a current charge capacity C_{CURRENT} of the cell unit 202, and reads the capacity data from the memory 414 to obtain the full capacity C_{FULL} of the cell unit 202 during the last charging and discharging cycle. As such, the SOC of the cell unit 202 is represented as equation (1):

SOC=(C_{CURRENT}/C_{FULL})*100% (1).

In one embodiment, the cell voltages and the temperatures of the battery cells 202_1-202_3 can be used to calibrate the calculated result of the SOC. The processor 412 can employ other methods to obtain the SOC of the cell unit 202, and is not limited to the example of FIG. 4.

Furthermore, the processor 412 determines whether to operate in the gauging mode or in the sensing mode, and configures the pins GP0-GP5 accordingly. More specifically, if an interrupt at the pin GP5 is detected, the processor 412 enters the gauging mode. In the gauging mode, the processor 412 configures the pin GP5 to generate a low electric signal and configures the pins GP0-GP4 to generate the control signals SIG_{CON1}-SIG_{CON5} according to the calculated SOC. In this embodiment, the control signals SIG_{CON1}-SIG_{CON5} can be analog signals, e.g., high electric signals and/or low electric signals, to enable the LEDs D1-D5 to display the SOC.

Moreover, in one embodiment, the processor 412 starts a timer to monitor the duration of the gauging mode. When a predetermined time period T is expired, the processor 412 re-configures the pins GP0-GP5 to switch the controller 204 to the sensing mode. In the sensing mode, the processor 412 generates control commands to the GPIO controller 416. Accordingly, the GPIO controller 416 configures the pin GP5 to generate a high electric signal, configures the pin GP4 to provide the supply voltage V_{SUPPLY}, and configures the pins GP0-GP3 to receive the temperature sense signals SIG_{SEN1}-SIG_{SEN4}. The controller 204 can include other components, and is not limited to the example of FIG. 4.

In one embodiment, the processor 412 is coupled to a bus 454 which is further connected to a host device (not shown in FIG. 4) such as a computer or a cell phone. The host device can forward a control command to the processor 412. Accordingly, the processor 402 selects an operation mode according to the control command. In other words, the controller 204 can operate between the sensing mode and the gauging mode in accordance with either the interrupt generated by the button 208 or a control command from the host device. The controller 204 can be switched between the gauging mode and the sensing mode in other ways, and is not limited to the example in FIG. 4.

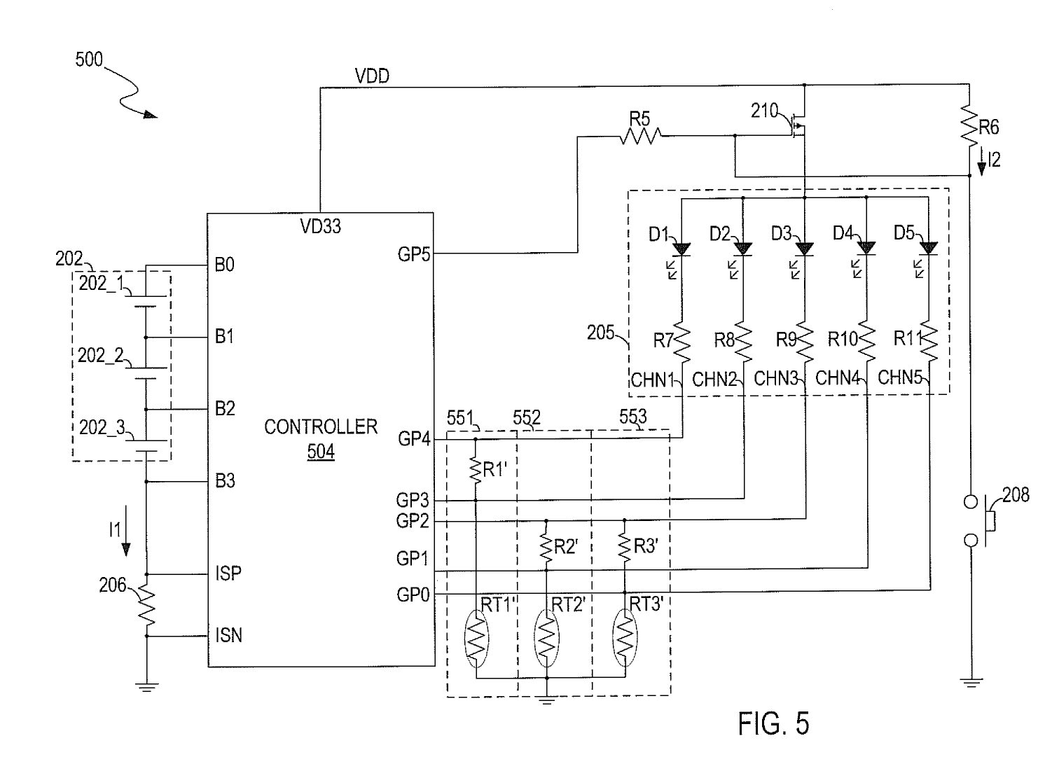

FIG. 5 illustrates another example of a block diagram of a battery system 500, in accordance with one embodiment of the present invention. Elements labeled the same as in FIG. 2 have similar functions. FIG. 5 is described in combination with FIG. 2, FIG. 3, and FIG. 4. The battery system 500 includes a battery cell unit 202, a controller 504, an indicator 205, multiple sensors 551-553, a resistor 206, a button 208, and a switch 210.

As described in relation to FIG. 2, the battery system 200 can include another number of sensors, and/or the indicator 205 can include another number of channels. In the example of FIG. 5, three sensors 551, 552 and 553 are included in the battery system 500. Each of the sensors 551-553 includes a resistor and a thermistor in series. For example, the sensor 551 includes a resistor R1′ and a thermistor RT1′, the sensor 552 includes a resistor R2′ and a thermistor RT2′, and the sensor 553 includes a resistor R3′ and a thermistor RT3′.

Similar to the controller 204, the controller 504 uses the pins of the three types I, II and III to display the SOC of the battery cell unit 202 in a gauging mode, and to receive three sense signals SIG_{SEN1}-SIG_{SEN3} in a sensing mode. More specifically, the pins GP0, GP1 and GP3 are type I GPIO pins. The pin GP0 applies the control signal SIG_{CON5} to the channel CHN5 in the gauging mode, and receives the sense signal SIG_{SEN3} generated by the sensor 553 in the sensing mode. The pin GP1 applies the control signal SIG_{CON4} to the channel CHN4 in the gauging mode, and receives the sense signal SIG_{SEN2} generated by the sensor 552 in the sensing mode. The pin GP3 applies the control signal SIG_{CON2} to the channel CHN2 in the gauging mode, and receives the sense signal SIG_{SEN1} generated by the sensor 551 in the sensing mode.

Moreover, both the pins GP2 and GP4 are type II GPIO pins. The pin GP2 applies the control signal SIG_{CON3} to the channel CHN3 in the gauging mode and provides a supply voltage V_{SUPPLY2} to drive the sensors 552 and 553 in the sensing mode. The pin GP4 applies the control signal SIG_{CON1} to the channel CHN1 in the gauging mode and provides a supply voltage V_{SUPPLY3} to drive the sensor 551 in the sensing mode.

Additionally, the pin GP5 of the controller 504 is a type III pin and operates similarly as the pin GP5 of the controller 204.

To summarize, although the number of the sensors and/or the number of the channels in the indicator 205 may be changed, the controller 204 can still operate in the gauging mode to display the SOC of the battery cell unit 202 on the indicator 205, and can operate in the sensing mode to receive the sense signals from the sensors. As long as pins of the type I, II and/or III are included in the controller, e.g., 204 or 504, the number of the pins can be decreased to reduce the chip area of the controller. Thus, the cost of the battery system 200 or 500 is reduced.

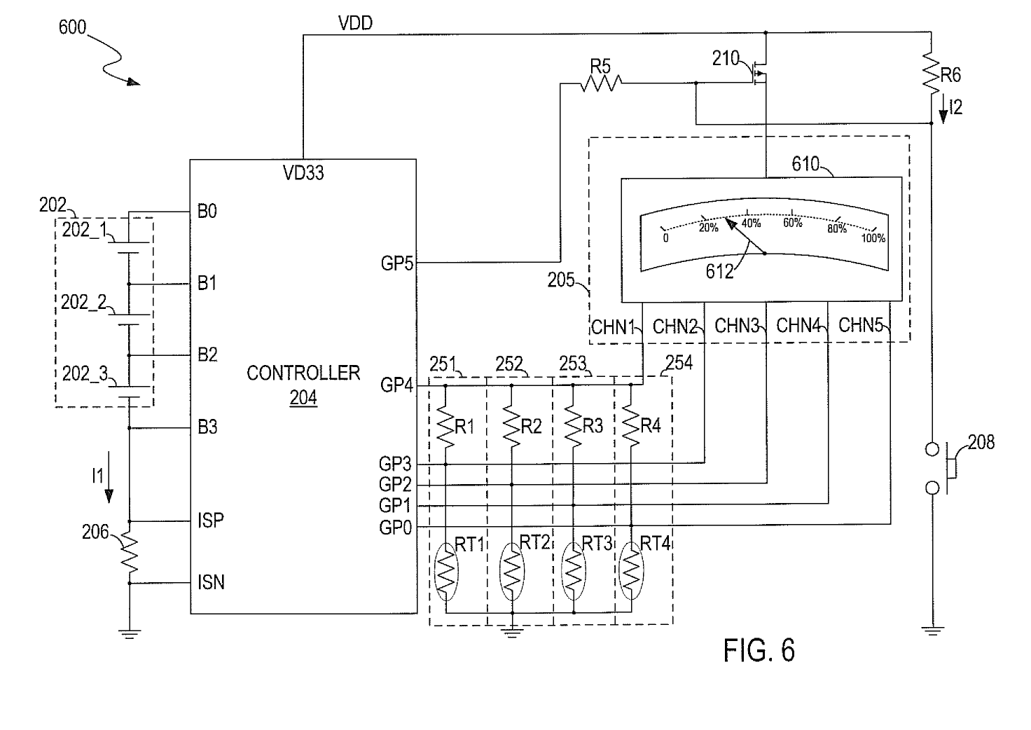

FIG. 6 illustrates another example of a block diagram of a battery system 600, in accordance with one embodiment of the present invention. Elements labeled the same as in FIG. 2 have similar functions. FIG. 6 is described in combination with FIG. 2, FIG. 3, and FIG. 4.

In the example of FIG. 6, the indicator 205 includes an instrument 610 (e.g., a gauge that includes a pointer that points to a value, or a gauge that displays a numerical value) operable for displaying the SOC of the battery cell unit 202 according to the control signals SIG_{CON1}-SIG_{CON5}, in the gauging mode. Similar to the battery system 200 in FIG. 2, the controller 204 controls the pin GP5 to turn on the switch 210 in the gauging mode and turn off the switch 210 in the sensing mode. In the gauging mode, the control signals SIG_{CON1}-SIG_{CON5} are multi-bit digital signals indicating, for example, a position of a pointer 612 in the instrument 610. For example, when SIG_{CON1}-SIG_{CON5} are 00000, 00001, 00010, 00100, 01000 and 10000, the pointer 612 can point to scales 0, 20%, 40%, 60%, 80% and 100%, respectively. In the sensing mode, the indicator 205 is disabled, and thus the pointer 612 keeps pointing to the scale 0. Additionally, the controller 204 controls the pins GP0-GP3 to receive the sense signals SIG_{SEN1}-SIG_{SEN4}, as described in relation to FIG. 2 and FIG. 3.

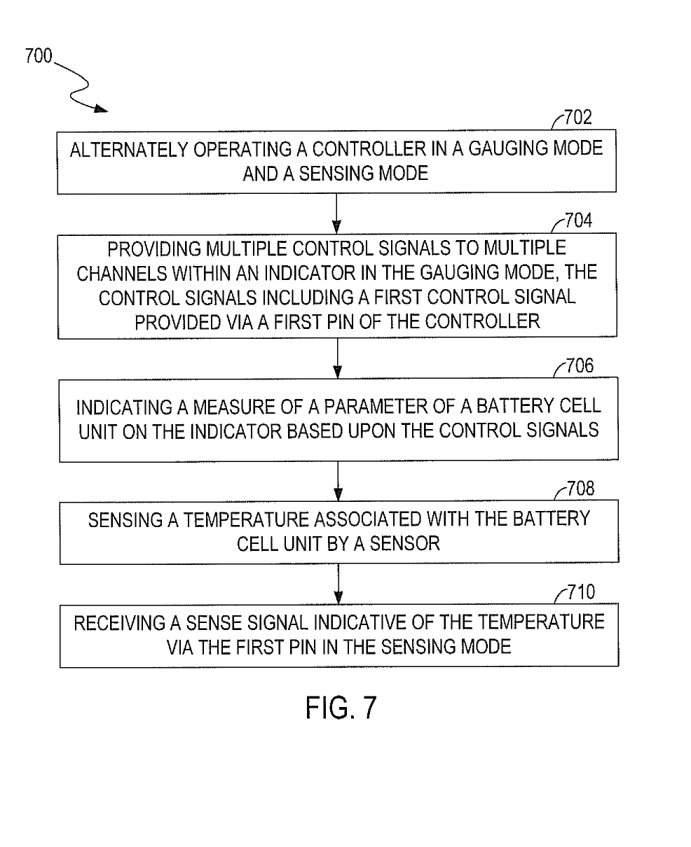

FIG. 7 illustrates a flowchart 700 of operations of the battery system 200, 500 or 600, in accordance with one embodiment of the present invention. FIG. 7 is described in combination with FIG. 2-FIG. 6. Although specific steps are disclosed in FIG. 7, such steps are examples. That is, the present invention is well suited to performing various other steps or variations of the steps recited in FIG. 7.

In block 702, a controller, e.g., the controller 204 or 504, is alternately operated in a gauging mode and a sensing mode. In one embodiment, an operation mode is selected from the sensing mode and the gauging mode according to control commands generated by a host device.

In block 704, multiple control signals, e.g., SIG_{CON1}-SIG_{CON5}, are provided to multiple channels, e.g., CHN1-CHN5, within the indicator in the gauging mode. The control signals include a first control signal provided via a first pin of the controller. In block 706, a measure of a parameter of a battery cell unit, e.g., the SOC of the battery cell unit 202, is indicated on the indicator based upon the control signals.

In block 708, a temperature associated with the battery cell unit is sensed by a sensor. In block 710, a sense signal indicative of the temperature is received via the first pin in the sensing mode. In one embodiment, the controller further includes a second pin. In the sensing mode, a supply voltage is provided to the sensor via the second pin. In the gauging mode, a second control signal of the control signals is applied to a second channel of the channels via the second pin. In one embodiment, the controller further includes a third pin. A switch is turned on and off to enable and disable the indicator via the third pin. In one embodiment, an interrupt from a button is received via the third pin. In response to the interrupt, the controller is operated in the gauging mode.

While the foregoing description and drawings represent embodiments of the present invention, it will be understood that various additions, modifications and substitutions may be made therein without departing from the spirit and scope of the principles of the present invention as defined in the accompanying claims. One skilled in the art will appreciate that the invention may be used with many modifications of form, structure, arrangement, proportions, materials, elements, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being indicated by the appended claims and their legal equivalents, and not limited to the foregoing description.

1. A battery system comprising:
an indicator having a plurality of channels and operable for displaying information about a battery cell unit in response to control signals received via said channels, wherein said channels include a first channel, and wherein said control signals include a first control signal;
a sensor operable for generating a sense signal; and
a controller having a first pin coupled to both said first channel and said sensor, wherein said controller is operable for controlling said first pin to apply said first control signal to said first channel when operating in a gauging mode and for controlling said first pin to receive said sense signal when operating in a sensing mode.

2. The battery system as claimed in claim 1, wherein said controller further comprises a second pin coupled to both said sensor and a second channel of said channels, and wherein said controller controls said second pin to provide a supply voltage to said sensor in said sensing mode and controls said second pin to apply a second control signal of said control signals to said second channel in said gauging mode.

3. The battery system as claimed in claim 1, wherein said controller further comprises a second pin, and wherein said controller is operable for controlling said second pin to turn on and off a switch to enable and disable said indicator.

4. The battery system as claimed in claim 3, wherein said second pin is further coupled to a button that generates an interrupt, and wherein said controller further controls said second pin to receive said interrupt and enters said gauging mode in response to said interrupt.

5. The battery system as claimed in claim 1, further comprising a switch that is turned on and off under control of said controller to enable and disable said indicator.

6. The battery system as claimed in claim 1, wherein said information is selected from the group consisting of: a state of charge of said battery cell unit, a current flowing through said battery cell unit, and a voltage of said battery cell unit.

7. The battery system as claimed in claim 1, wherein said indicator comprises a plurality of light emitting diodes coupled to said channels.

8. The battery system as claimed in claim 1, wherein said indicator comprises a gauge coupled to said channels.

9. The battery system as claimed in claim 1, wherein said sensor comprises a thermistor.

10. The battery system as claimed in claim 1, wherein said controller is further coupled to a host device, and operates between said sensing mode and said gauging mode according to control commands generated by said host device.

11. The battery system as claimed in claim 1, wherein said information comprises a state of charge of said battery cell unit, and wherein said controller comprises:
a machine-readable medium operable for storing machine-executable instructions and capacity data indicating a full capacity of said battery cell unit; and
a processor coupled to said machine-readable medium and operable for executing said machine-executable instructions to receive a plurality of voltage detection signals indicating voltages of cells in said battery cell unit, receive a current detection signal indicating a current of said battery cell unit, and calculate said state of charge according to a combination of said voltage detection signals, said current detection signal and said capacity data.

12. A controller for controlling a battery cell unit, said controller comprising:
a first plurality of pins coupled respectively to a plurality of channels of an indicator, wherein said first plurality of pins comprise a first pin that is also coupled to a sensor; and
a second pin coupled to a switch and operable for turning on and off said switch to enable and disable said indicator,
wherein said controller is operable for controlling said second pin to enable said indicator in a gauging mode and to disable said indicator in a sensing mode, for controlling said first plurality of pins to display information about said battery cell unit on said indicator in said gauging mode, and for controlling said first pin to receive a sense signal generated by said sensor in said sensing mode.

13. The controller as claimed in claim 12, wherein said second pin is further coupled to a button, and wherein said controller further controls said second pin to receive an interrupt when said button is pressed, and enters said gauging mode in response to said interrupt.

14. The controller as claimed in claim 12, wherein said first plurality of pins comprise a third pin that is also coupled to said sensor, and wherein said controller further generates a supply voltage at said third pin to drive said sensor in said sensing mode.

15. The controller as claimed in claim 12, wherein said sensor comprises a thermistor operable for sensing a temperature of a battery cell in said battery cell unit.

16. The controller as claimed in claim 12, wherein said information comprises a state of charge of said battery cell unit, and wherein said controller further comprises:
a third pin operable for receiving a voltage detection signal indicating a voltage associated with said battery cell unit; and
a fourth pin operable for receiving a current detection signal indicating a current flowing through said battery cell unit,
wherein said controller uses said voltage detection signal and said current detection signal to calculate a value of said state of charge.

17. A method for monitoring a battery cell unit, said method comprising:
alternately operating a controller in a gauging mode and a sensing mode;
providing a plurality of control signals to a plurality of channels within an indicator in said gauging mode, wherein said control signals comprises a first control signal provided via a first pin of said controller;
indicating a measure of a parameter of said battery cell unit on said indicator based upon said control signals;
sensing a temperature associated with said battery cell unit by a sensor; and
receiving a sense signal indicative of said temperature via said first pin in said sensing mode.

18. The method as claimed in claim 17, further comprising:
providing a supply voltage to said sensor via a second pin of said controller in said sensing mode; and
applying a second control signal of said control signals to a second channel of said channels via said second pin in said gauging mode.

19. The method as claimed in claim 17, further comprising:
turning on and off a switch to enable and disable said indicator via a second pin of said controller.

20. The method as claimed in claim 19, further comprising:
receiving an interrupt from a button via said second pin; and
operating said controller in said gauging mode in response to said interrupt.

21. The method as claimed in claim 17, further comprising:
selecting an operation mode from said sensing mode and said gauging mode according to control commands generated by a host device.
